(19) United States
(12) Patent Application Publication
(10) Pub. No.: US 2019/0269278 A1
(43) Pub. Date: Sep. 5, 2019

(54) HERB GRINDER

(71) Applicant: Tilray, Inc., Seattle, WA (US)

(72) Inventors: Alex Neury, New York, NY (US); Daryl Mosely, New York, NY (US)

(21) Appl. No.: 16/290,355

(22) Filed: Mar. 1, 2019

Related U.S. Application Data
(60) Provisional application No. 62/637,474, filed on Mar. 2, 2018.

(51) Int. Cl. A47J 42/34

(52) U.S. Cl. CPC A47J 42/34

(57) ABSTRACT

Herbs are commonly used and consumed in ground form. Depending on, for example, the size, shape, and type of herb or the desired application, the appropriate form of the ground herb may vary. An herb grinder with an adjustment plate for grinding an herb to multiple ground forms is described herein. Such a disclosure is advantageous over traditional herb grinders at least in that it reduces unnecessary clutter and operational inefficiencies by having one herb grinder configured to grind an herb into multiple forms.

### RELATED MATTERS

This application claims the benefit of U.S. Provisional Application No. 62/637,474, filed Mar. 2, 2018, the contents of which are incorporated herein by reference.

### TECHNICAL FIELD

This disclosure generally relates to grinders for grinding herbs of various kinds.

### SUMMARY

Herbs are commonly used and consumed in ground form. Depending on, for example, the size, shape, and type of herb or the desired application, the appropriate form of the ground herb may vary. Existing methods for grinding herbs, especially using handheld devices, consist of having a single grinder dedicated to grinding the herb to a single ground form. Using such devices can be cumbersome for users who desire herbs in multiple ground forms. In order to do so, the user must have multiple herb grinders, which can result in unnecessary clutter and operational inefficiencies.

An herb grinder with an adjustment plate for grinding an herb to multiple ground forms is described herein. An illustrative herb grinder can contain a grinding chamber and an adjustment plate. The grinding chamber can include a base with a base plate and one more concentric rings of base teeth radially spaced from one another. The grinding chamber can include a cap configured to be removably coupled to the base and having a circular cap plate and one or more concentric rings of cap teeth. The adjustment plate can be configured to be coupled (e.g., coaxially) to the base and have concentric rings of adjustment holes corresponding to base holes. When the adjustment plate is coupled to the base, a central axis of the adjustment plate can be aligned with a central axis of the base such that the adjustment plate and the base are aligned coaxially. The adjustment holes and the base holes can form overlapping holes.

In operation of such an herb grinder, the user can adjust the size of the overlapping holes in order to adjust the form that the herb is ground into. The cap and the base can be configured to rotate relative to each other when the cap is covering the base. The user can rotate the cap and the base to grind an herb within the grinding chamber between the base teeth and the cap teeth.

Grinding the herb in such a fashion can cause ground herb to move through the overlapping holes. Such a disclosure is advantageous over traditional herb grinders at least in that it reduces unnecessary clutter and operational inefficiencies by having one herb grinder configured to grind an herb into multiple forms.

The details of one or more examples are set forth in the accompanying drawings and the description below. Other features, objects, and advantages will be apparent from the description and drawings.

### BRIEF DESCRIPTION OF DRAWINGS

The following drawings are illustrative of particular embodiments of the present invention and therefore do not limit the scope of the invention. The drawings are not necessarily to scale (unless so stated) and are intended for use in conjunction with the explanations in the following description. Embodiments of the invention will hereinafter be described in conjunction with the appended drawings, wherein like numerals denote like elements.

FIG. 1 is perspective view of a traditional herb grinder with herbs.

FIG. 2 is a perspective view of an illustrative herb grinder.

FIG. 3A is an exploded perspective view of an illustrative herb grinder.

FIG. 3B is an exploded perspective view of an illustrative herb grinder.

FIG. 4A is a perspective view of a cap for an illustrative herb grinder.

FIG. 4B is a perspective view of a cap for an illustrative herb grinder.

FIG. 4C is a bottom elevational view of a cap for an illustrative herb grinder.

FIG. 5A is a perspective view of a circular base plate for an illustrative herb grinder.

FIG. 5B is a perspective view of a circular base plate for an illustrative herb grinder.

FIG. 5C is a top elevational view of a circular base plate for an illustrative herb grinder.

FIG. 5D is a bottom elevational view of a circular base plate for an illustrative herb grinder.

FIG. 6 is a cross sectional view of an illustrative herb grinder.

FIG. 7A is a perspective view of a circular adjustment plate for an illustrative herb grinder.

FIG. 7B is a perspective view of a circular adjustment plate for an illustrative herb grinder.

FIG. 7C is a bottom elevational view of a circular adjustment plate for an illustrative herb grinder.

FIG. 8A is a bottom elevational view of a circular base plate for an illustrative herb grinder.

FIG. 8B is a bottom elevational view of a circular base plate and a circular adjustment plate in a first position for an illustrative herb grinder.

FIG. 8C is a bottom elevational view of a circular base plate and a circular adjustment plate in a second position for an illustrative herb grinder.

FIG. 9A is a perspective view of a pollen sifter for an illustrative herb grinder.

FIG. 9B is a perspective view of a pollen sifter for an illustrative herb grinder.

FIG. 10 is a flow chart of an illustrative method for grinding herbs.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, and/or dimensions are provided for selected elements. Those skilled in the art will recognize that many of the noted examples have a variety of suitable alternatives.

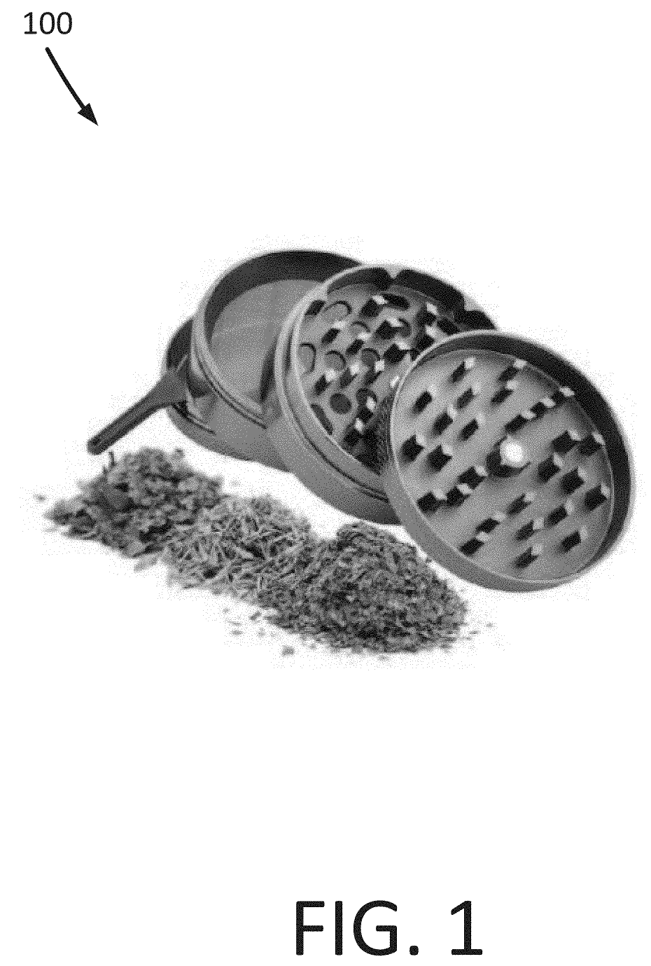

FIG. 1 shows a traditional herb grinder 100. As shown, the herb is placed into the herb grinder 100 for grinding. In some embodiments, the herb is cannabis. Traditional herb grinders 100 are configured to grind the herb to only a single, preset form. In other words, a user could only grind an herb to one form and would need a separate herb grinder 100 to grind an herb into another form. Thus, an improved herb grinder would allow for grinding an herb in multiple forms (e.g., multiple different degrees of granularity) using a single herb grinder.

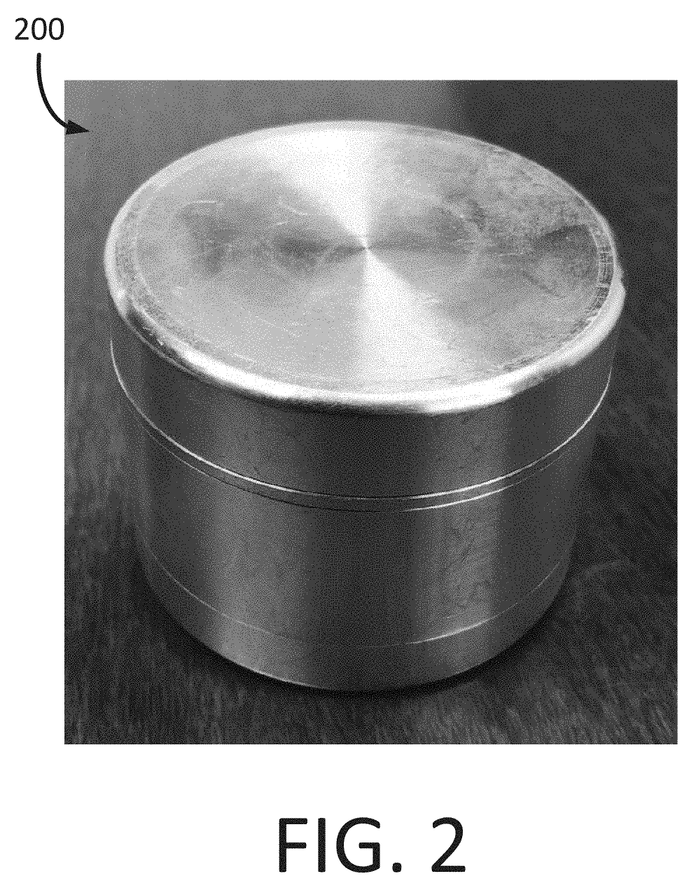

FIG. 2 shows an illustrative portable herb grinder 200. The herb grinder can be adapted to fit comfortably within a user's hand. As described elsewhere herein, a cap in an illustrative herb grinder can include a cap plate. For example, in some embodiments, a diameter of the cap plate is between about two inches and three inches. In such embodiments, the herb grinder may have exterior features such as grips or modified surfaces (e.g., concavities, corrugations, etc.) to facilitate hand operation. In some embodiments, the cap plate can be much larger. Such large diameter cap plates can accommodate more automated industrial applications, for example, with larger amounts of herbs or faster grinding speeds or processes.

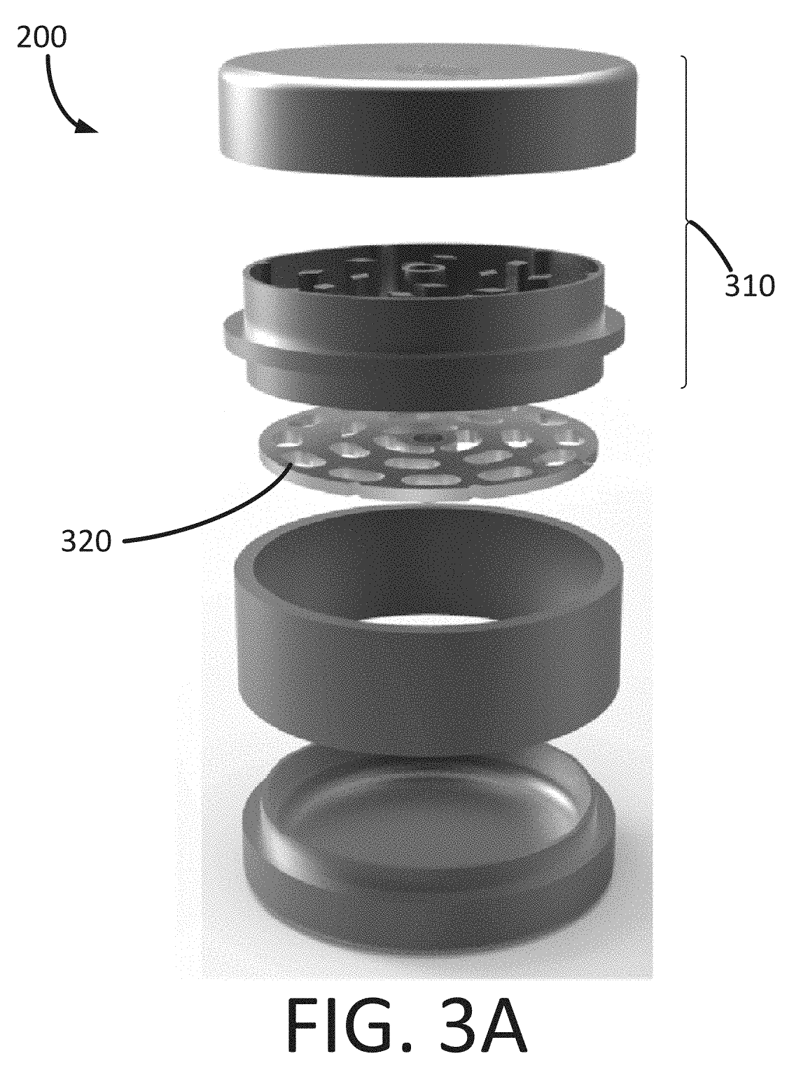

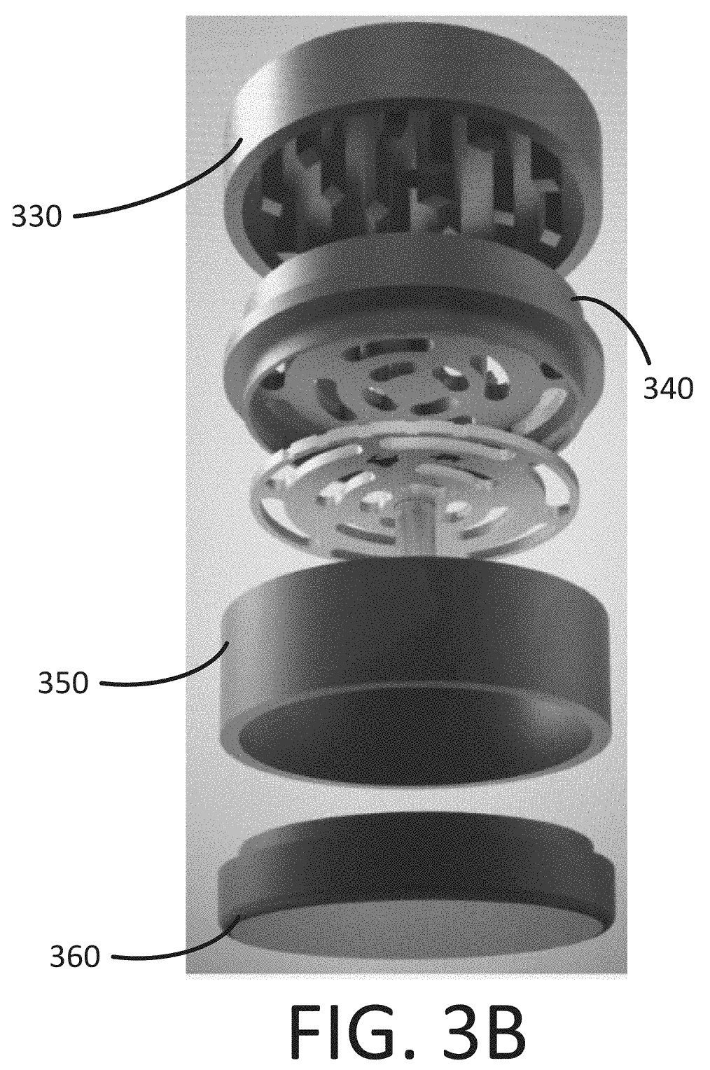

FIGS. 3A and 3B show the illustrative herb grinder 200. As seen in FIG. 3A, the herb grinder 200 can include a grinding chamber 310 and a circular adjustment plate 320. The grinding chamber 310 can include a cap 330 and a base 340 as shown in FIG. 3B. The cap 330 can be configured to be coupled (e.g., coaxially) to the base. In some embodiments, the cap 330 can be configured to removably cover the base.

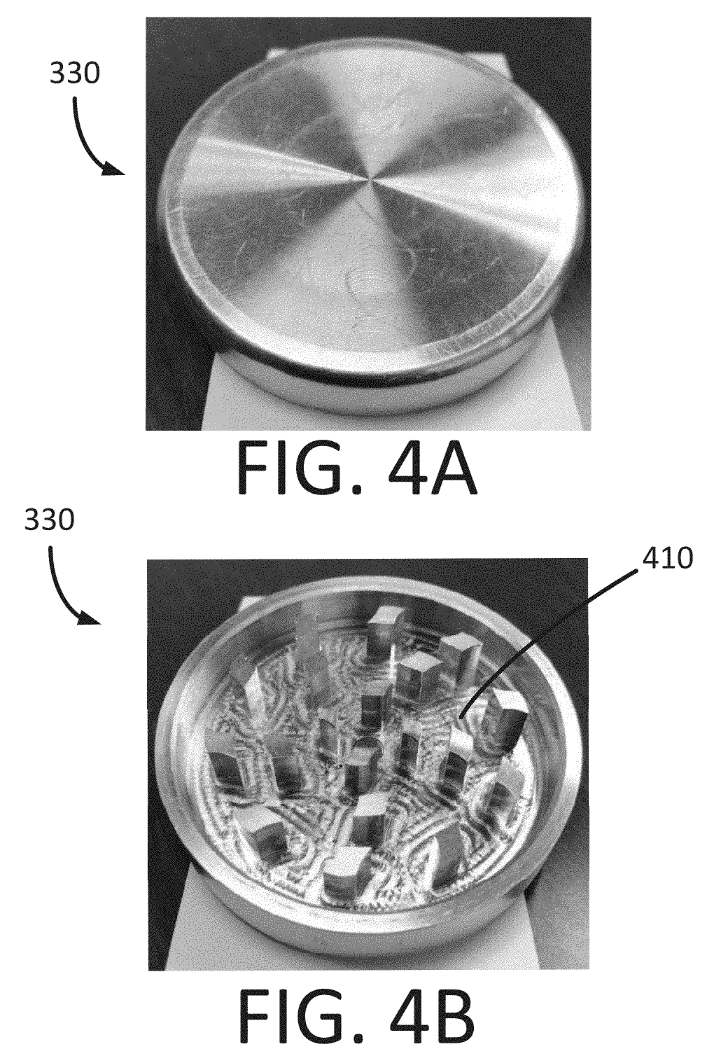

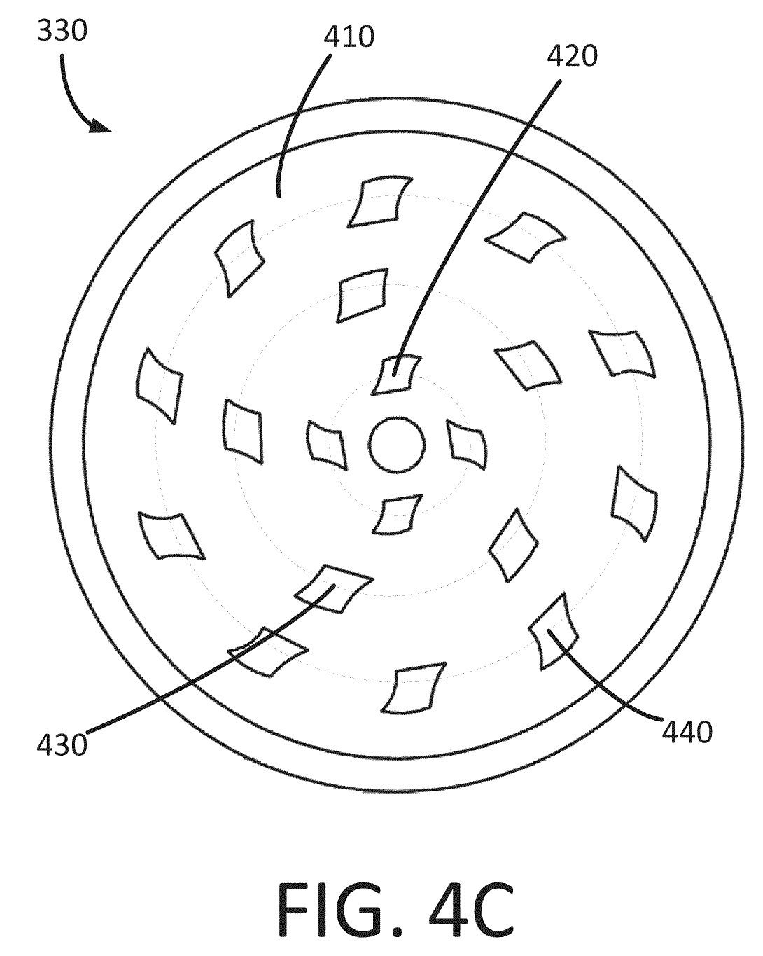

FIGS. 4A-4C show a cap 330 that can be used in some illustrative embodiments of herb grinders. The cap 330 can include a circular cap plate 410 as shown in FIG. 4B. The cap 330 can include one or more concentric rings of cap teeth 420, 430, 440 as indicated by the dashed lines shown in FIG. 4C. In some embodiments, the cap 330 comprises three rings of cap teeth 420, 430, 440. The rings of cap teeth 420, 430, 440 can extend away from the cap plate 410. In many embodiments, the cap teeth can extend to span the height of the cap 330 or can extend to be just out of contact with the base when assembled or operated. The cap teeth can be of the same or varying shape and size.

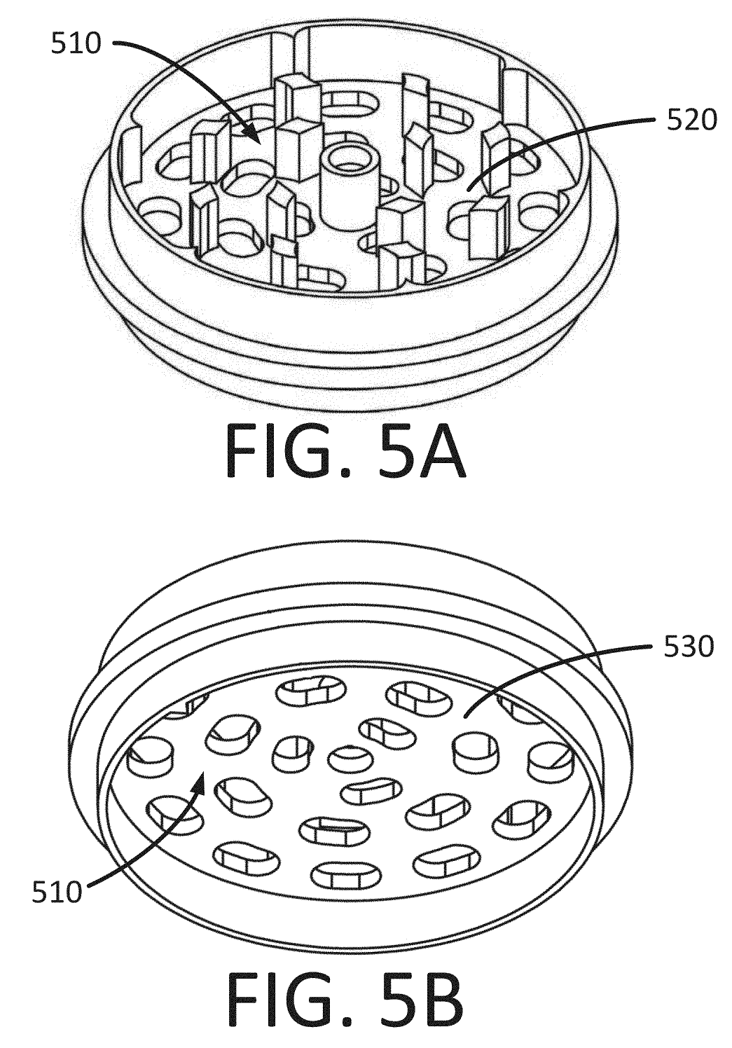

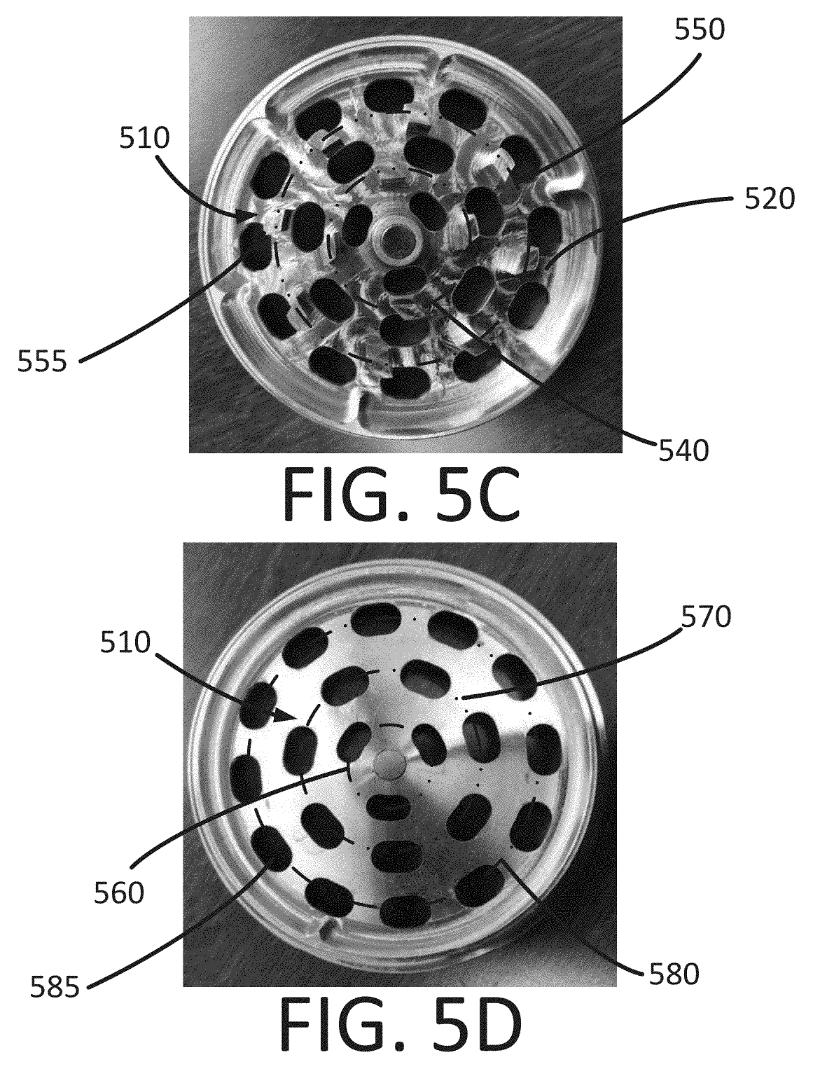

FIGS. 5A-5D show an illustrative circular base plate 510. The base plate 510 can include an interior surface 520 as shown in FIG. 5A. The base plate 510 can include an exterior surface 530. The base plate 510 can be adapted to mechanically attach to other components of the base. As discussed elsewhere herein, the base plate 510 can be adapted to mechanically attach to and be axially aligned with the cap.

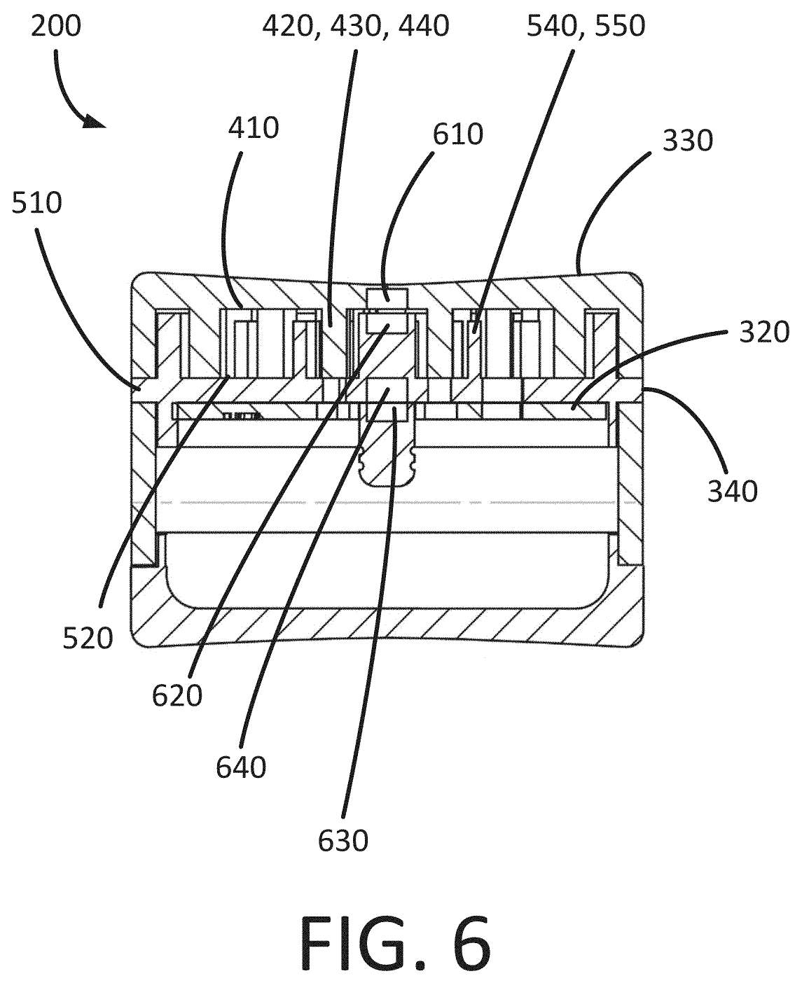

The base 340 can be positioned so as to align with the cap 330 as illustrated in FIG. 6. The cap plate 410 can oppose the interior surface 520 of the base plate 510 when the cap 330 is covering the base 340. The cap plate 410 can be coaxial with the interior surface 520 of the base plate 510 when the cap 330 is covering the base 340.

Referring back to FIG. 5C, the base 340 can include a base plate 510. The base can include one or more concentric rings of base teeth 540, 550 as indicated by the dashed lines. In some embodiments, the base can include two rings of base teeth 540, 550. Other embodiments of the base can have more or fewer concentric rings of base teeth 540, 550. For example, in certain embodiments, the base can include one or three rings of base teeth.

The base teeth 555 can be positioned such that they are complementary to, but do not interfere with, the cap teeth during assembly or operation. The rings of base teeth 540, 550 can extend away from the interior surface 520 of the base plate 510. In many embodiments, the base teeth 555 can extend to span the height of the base plate 510 or can extend to be just out of contact with the cap when assembled or operated. Each ring of base teeth 540, 550 can be radially spaced from one another. One ring of base teeth 540 can be nearer to the center of the base plate 510 than is another ring of base teeth 550. The base teeth 555 can be of the same or varying shape and size.

The base plate 510 can include one or more concentric rings of base holes 560, 570, 580 as indicated by the dashed lines shown in FIG. 5D. Each ring of base holes 560, 570, 580 can be radially spaced from one another. One ring of base holes 560 can be nearer to the center of the base plate 510 than is another ring of base holes 570, and that ring of base holes 570 can be nearer to the center of the base plate 510 than is another ring of base holes 580. The base holes 585 can be positioned such that they are at a different radial position than the base teeth. In some embodiments, the base plate 510 can include three rings of base holes 560, 570, 580. Other embodiments of the base plate can have more or fewer rings of base holes 560, 570, 580. For example, in certain embodiments, the base holes 585 can include two or four rings of base holes. The rings of base holes 540, 550 can extend through the base plate 510. The base holes 585 can be of the same or varying shape and size.

In some embodiments, each ring of cap teeth can be radially aligned with a corresponding ring of base holes 560, 570, 580 when the cap is covering the base. A first ring of cap teeth can be spaced from the center of the cap plate by a first radial distance, a second ring of cap teeth can be spaced from the center of the cap plate by a second radial distance, and a third ring of cap teeth can be spaced from the center of the cap plate by a third radial distance. In such embodiments, when the cap is covering the base such that the center of the cap plate is coaxial with the center of the base plate 510, a first ring of base holes 560 can be spaced from the center of the base plate 510 by the first radial distance, the second ring of base holes 570 can be spaced from the center of the base plate 510 by the second radial distance, and the third ring of base holes 580 can be spaced from the center of the base plate 510 by the third radial distance. As discussed elsewhere herein, the cap can be configured to rotate relative to the base. In such embodiments, the base holes 585 can be positioned in such that they are opposite to, but do not interfere with, the cap teeth in certain positions during assembly or operation.

FIG. 6 shows how the cap 330 and base 340 of the herb grinder can be configured to be mechanically connected. In many embodiments, the cap 330 can include an axial cap magnet 610. In many embodiments, the base 340 can include an axial base magnet 620. In some embodiments, the cap 330 and the base 340 can be configured to be coupled together by the axial cap magnet 610 and the axial base magnet 620.

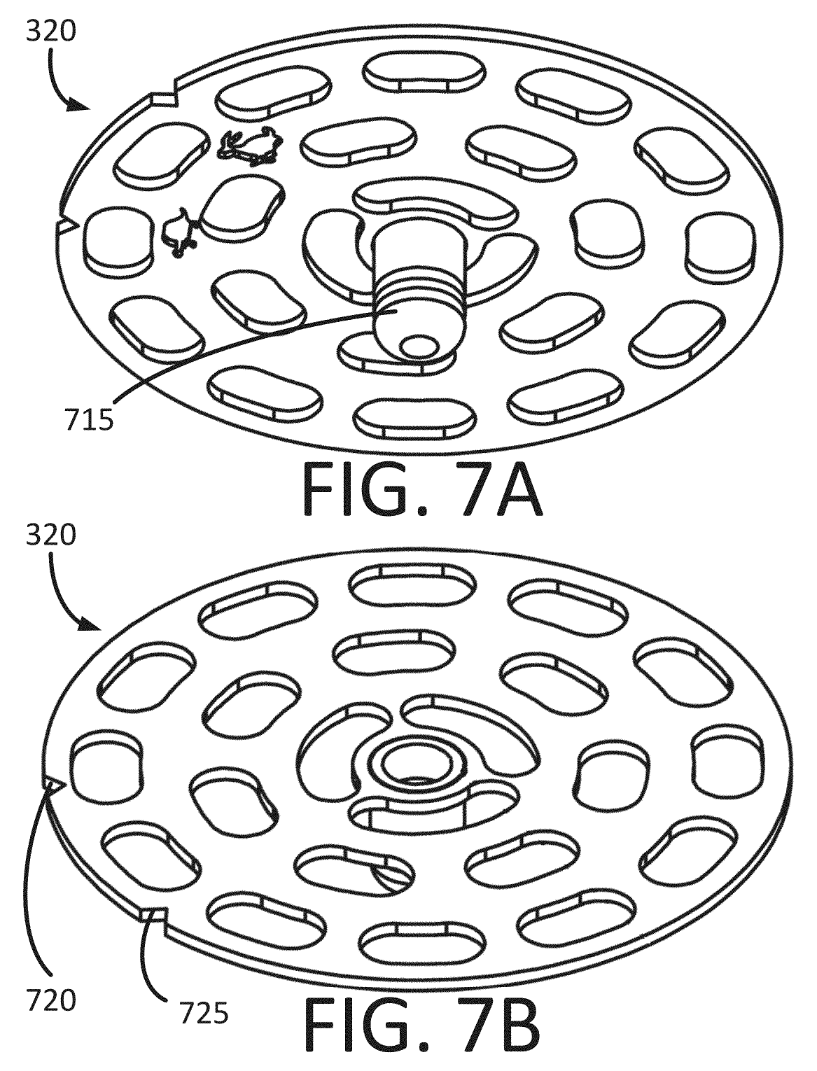

An illustrative adjustment plate 320 is shown in FIGS. 7A and 7B. The adjustment plate 320 can be configured to be coupled (e.g., coaxially) to the exterior surface of the base plate. The adjustment plate 320 can have a grip portion 715 adapted to facilitate coupling the adjustment plate to the base plate (e.g., a handle, indentation, etc.). As discussed elsewhere herein, the adjustment plate 320 can be coupled to the exterior surface of the base plate in a manner that prevents the adjustment plate 320 and the base from rotating relative to each other.

The adjustment plate 320 can include one or more concentric rings of adjustment holes 730, 740, 750 as shown in FIG. 7C. In some embodiments, the adjustment plate 320 can include three rings of adjustment holes 730, 740, 750. Other embodiments of the adjustment plate can have more or fewer rings of adjustment holes 730, 740, 750. For example, in certain embodiments, the adjustment holes 710 can include two or four rings of adjustment holes. The rings of adjustment holes 730, 740, 750 can extend through the adjustment plate 320. The adjustment holes 710 can be of the same or varying shape and size. The adjustment holes 710 can be positioned such that they are at a different radial position than the base teeth. The adjustment holes can be of the same or varying shape and size.

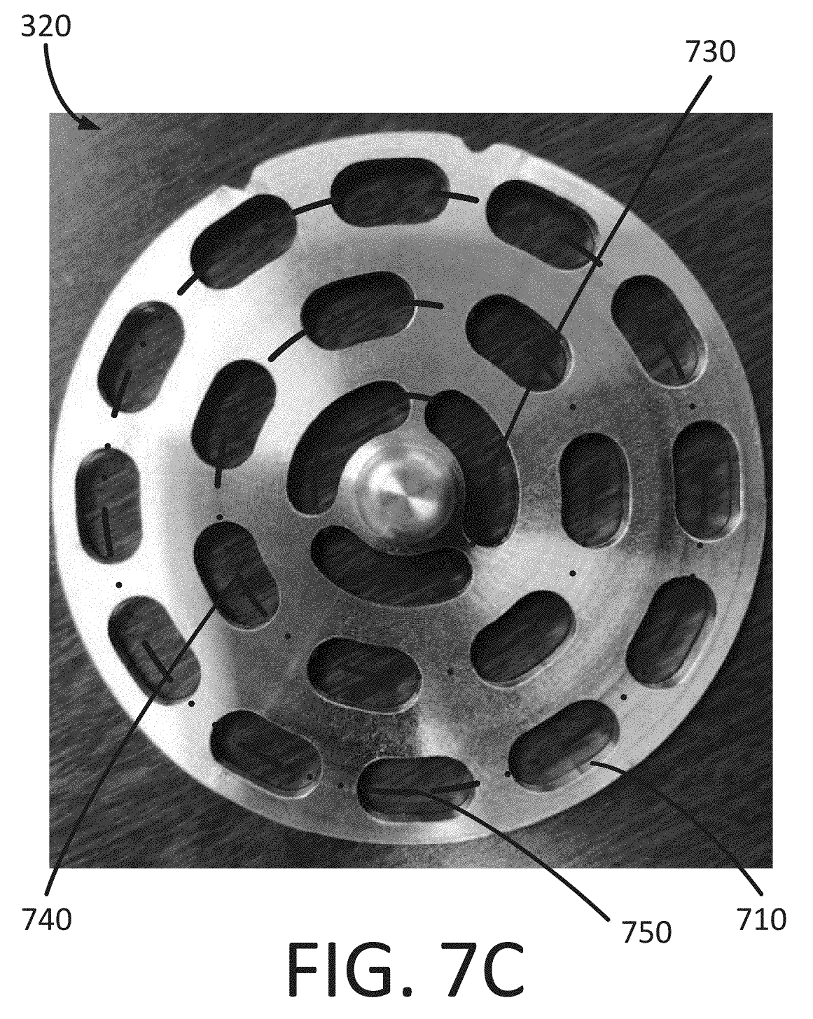

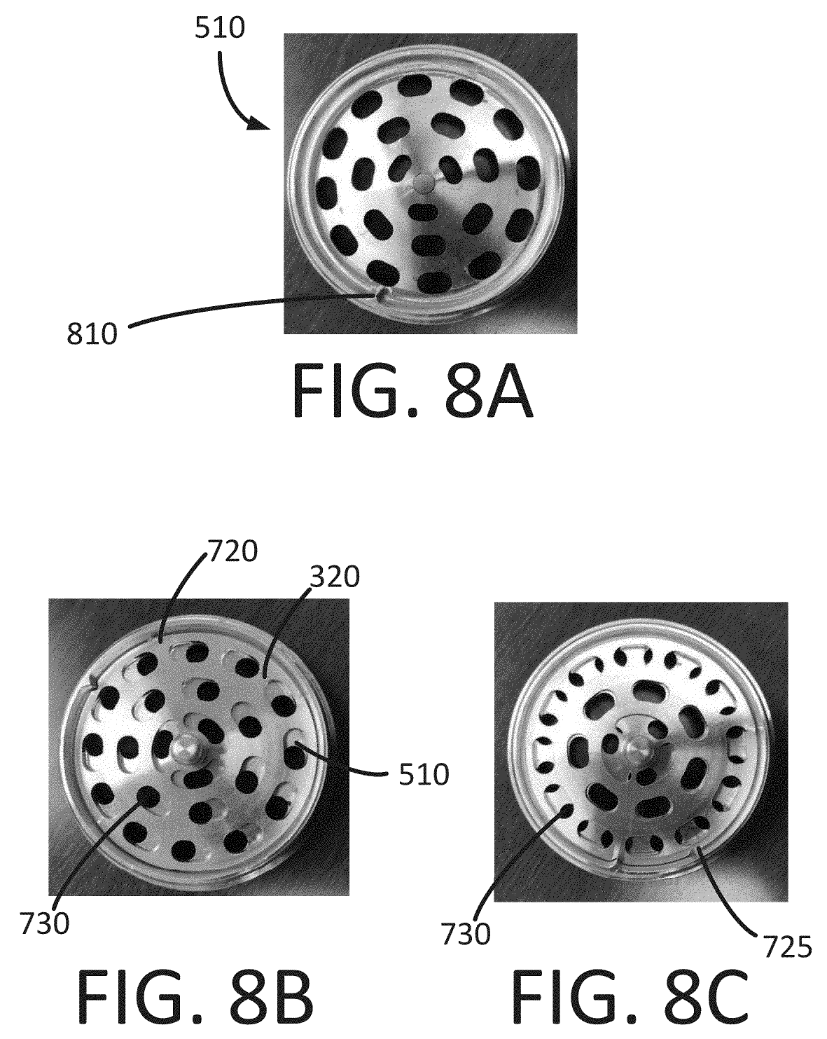

FIGS. 8A-8C shows how the base holes and the adjustments holes can be positioned relative to one another when the base 510 and the adjustment plate 320 are coaxially coupled to one another. Each ring of adjustment holes can be radially aligned with a corresponding ring of base holes when the adjustment plate 320 is coupled to the base plate 510. At least some of the adjustment holes can at least partially overlap with at least some of the base holes.

At least some of the adjustment holes can form overlapping holes 730. That is, for example, at least a portion of the adjustment holes can overlap with at least a portion of the base holes. The overlapping portions of the adjustment holes and the base holes can form overlapping holes 730. At least a portion of the overlapping holes 730 can extend through both the adjustment plate 320 and the base plate 510. A combined area of the overlapping holes 730 can be smaller than a combined area of the base holes. That is, for example, the area of the overlapping holes 730 that extends through both the adjustment plate 320 and the base plate 510 can be less than the sum of the areas of base holes themselves. As another example, the area of a single overlapping hole can be less than the sum of the adjustment holes and base holes that form the overlapping holes 730. In some embodiments, the combined area of the overlapping holes 730 can be a specified percentage (e.g., 1%, 10%, 25%, 50%, 75%, 90%, 99%), depending on how fine or how coarse the herb is to be ground. The adjustment settings can be produced to a full range of adjustable hole size depending on manufacturing specifications.

Referring back to FIG. 6, the base 340 and the adjustment plate 320 of the herb grinder 200 can be configured to be mechanically connected. In some embodiments, the adjustment plate 320 can include an axial adjustment plate magnet 630. In some embodiments, the base and the adjustment plate 320 can be configured to be coupled together by the axial base magnet 630 and the axial adjustment plate magnet 640.

Referring now to FIGS. 7A-7C, in some embodiments, the adjustment plate 320 can have first and second notches 720, 725 as shown in FIG. 7B. Generally, the first and second notches 720, 725 have numerous shapes and sizes. The first and second notches 720, 725 can be on the outer periphery of the adjustment plate 320. The first and second notches 720, 725 can be of a shape and size that corresponds to a mating component in the base. The first and second notches can be adapted to the herb grinder's particular application. For example, first and second notches for handheld applications may be triangular while first and second notches for industrial type applications may be circular to reduce fatigue. An illustrative herb grinder may contain more or fewer notches, for example, to accommodate various sizes of overlapping holes.

In such embodiments, as shown in FIGS. 8A-8C, the first and second notches can be configured to individually mate with a tab 810 in the base. The first and second notches 720, 725 and the tab 810 can prevent the adjustment plate 320 and the base plate 510 from rotating relative to each other in either of the first or second orientations. In some embodiments, the first-and-second-notch-and-tab combinations can be situated on the mating surfaces of the adjustment plate and the base plate. Other embodiments of the herb grinder can be configured to mechanically position the adjustment plate 510 relative to the base plate 320, for instance, using geared connections or a series of magnets.

The herb grinder can have an adjustment plate with multiple orientations corresponding to various sizes of overlapping holes. In some embodiments, the adjustment plate 320 can be configured to be coupled to the base plate 510 in first and second orientations as shown in FIGS. 8A-8C. In such embodiments, the combined area of the overlapping holes can be larger when the adjustment plate 320 is coupled to the base plate 510 in the first orientation than when the adjustment plate 320 is coupled to the base plate 510 in the second orientation. For example, FIG. 8B shows the adjustment plate 510 in a first orientation while FIG. 8C shows the adjustment plate 510 in a second orientation. In some embodiments, the adjustment plate can have a number of evenly spaced orientations (e.g., nine orientations spaced apart by 40°). The overlapping holes' combined area at the different orientations can be even percentages of the base holes' combined area (e.g., nine orientations with the overlapping holes having combined areas that are 10%, 20%, 30%, 40%, 50%, 60%, 70%, 80%, and 90% of the base holes' combined area). The adjustment plate can have 99 orientations, with the overlapping holes' combined area being 1% to 99% of the base holes' combined area.

Referring to FIG. 6, the cap 330 and the base 340 can be configured to mate with one another for operation. The cap 330 and the base 340 can be configured to rotate relative to each other when the cap 330 is covering the base 340. Rotating the cap 330 and the base 340 can grind an herb within the grinding chamber between the base teeth 540, 550 and the cap teeth 420, 430, 440. Rotating the cap and the base can cause ground herb to move through overlapping holes. In some embodiments, the cap and the base can be configured to have more accelerated rotation in one direction than the opposite direction.

Referring back to FIGS. 3A and 3B, in some embodiments, the herb grinder can further comprise a pollen sifter 350 and a sift catcher 360. In some embodiments, the pollen sifter 350 can be configured to be coupled to the grinding chamber 310. The pollen sifter 350 and the sift catcher 360 can be positioned beneath the base plate.

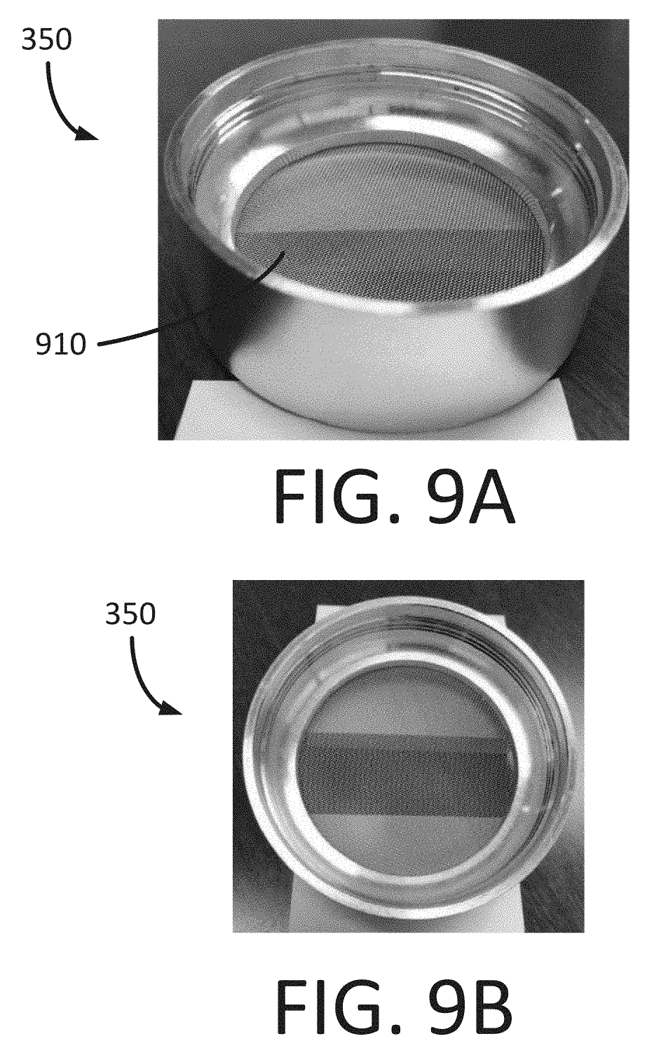

FIGS. 9A and 9B show an illustrative pollen sifter 350. The pollen sifter 350 can collect the ground herb that has moved through the overlapping holes. As shown in FIG. 9B, the pollen sifter 350 can have a pollen sifter screen 910. The pollen sifter screen 910 can, for example, be made from a porous material such as a mesh, or be constructed from a series of structural features, such as a series of bars or holes. The pollen sifter screen 910 can be affixed or removably attached to the pollen sifter. The pollen sifter screen 910 in an axial position can be biased towards the end that coupled to the sift catcher. Such an orientation of the pollen sifter screen 910 can allow for multiple grinding operations before the pollen sifter is filled.

An illustrative sift catcher 360 is shown in FIGS. 3A and 3B. In some embodiments, the sift catcher 360 can be configured to be coupled to the pollen sifter 350. The sift catcher 360 can collect sift that passes through the pollen sifter screen.

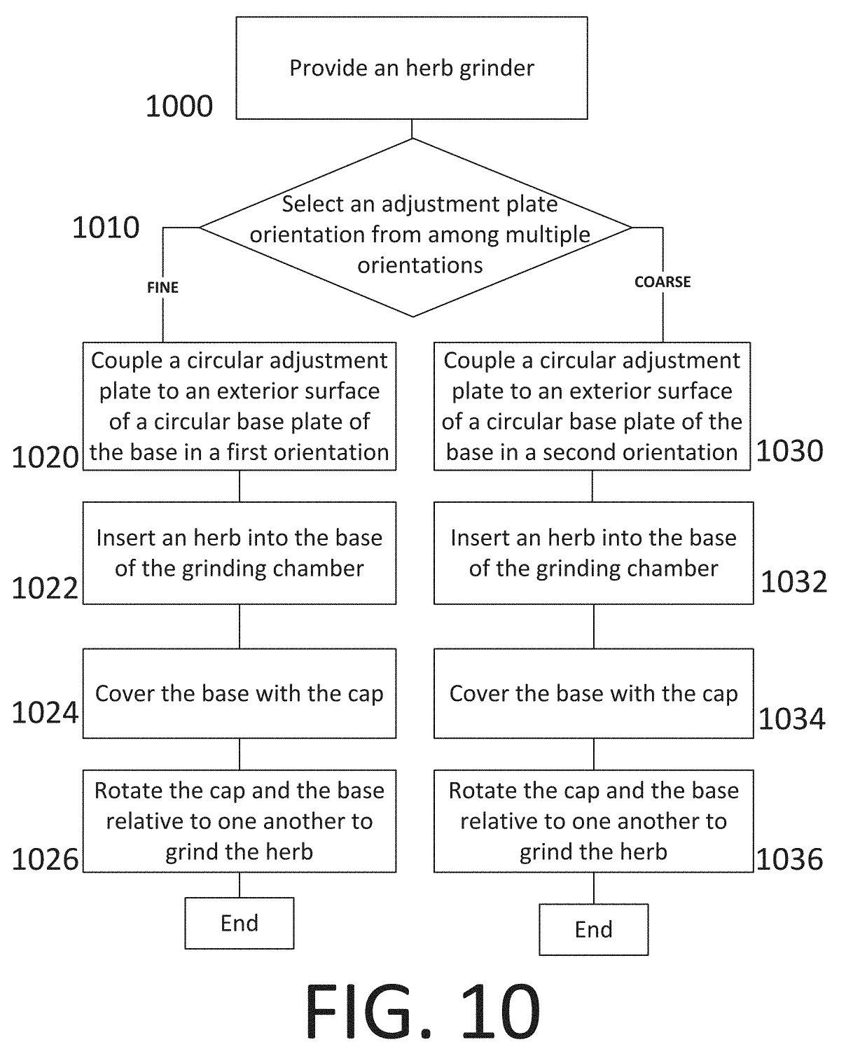

An illustrative method for grinding herbs can is shown in FIG. 10. The method for grinding herbs can include providing an herb grinder such as those described herein 1000. In many embodiments, the method can further include selecting an adjustment plate orientation from among multiple orientations 1010. In some embodiments, each orientation can correspond to a different combined area of overlapping holes. For example, one orientation can result in herb that is ground to a first degree of granularity (e.g., fine), while another orientation can result in herb that is ground to a second degree of granularity (e.g., coarse).

The method can include coupling (e.g., coaxially) a circular adjustment plate to an exterior surface of a circular base plate of the base 1020, 1030. As shown, selecting an adjustment plate orientation to correspond with finely ground herb can result in coaxially coupling the adjustment plate to the exterior surface of the base plate in a first orientation 1020. Also as shown, selecting an adjustment plate orientation to correspond with coarsely ground herb can result in coaxially coupling the adjustment plate to the exterior surface of the base plate in a second orientation 1030. As discussed elsewhere herein, coupling the adjustment plate to the base plate in an illustrative herb grinder can form overlapping holes. The method can include inserting an herb into the base of the grinding chamber 1022, 1032. The method can include covering the base with the cap 1024, 1034.

After the base is covered by the cap, the herb can be ground. The method can include rotating the cap and the base relative to one another to grind the herb between the base teeth and the cap teeth 1026, 1036. Rotating the cap and the base relative to one another can cause the herb, in ground form, to move through the overlapping holes, with the adjustment plate being prevented from rotating relative to the base. In some embodiments, the combined area of the overlapping holes is a specified percentage of the combined area of the base holes, as noted elsewhere herein. That is, for example, the area of the overlapping holes that extends through both the adjustment plate and the base plate can be less than the areas of base holes themselves. As another example, the size of a single overlapping hole can be less than the sum of the adjustment holes and base holes that form the overlapping holes. In some embodiments, rotating the cap and the base relative to one another can include manually rotating the cap and the base relative to one another. In some embodiments, the method can further include orienting the herb grinder such that the cap is vertically above the base while rotating the cap and the base relative to one another. In such embodiments, the herb, in ground form, can fall through the overlapping holes.

In many embodiments, the method can further include collecting the herb, in ground form, that has moved through the overlapping holes in a pollen sifter. The pollen sifter can be coupled to the grinding chamber. The pollen sifter can have a pollen sifter screen. In some embodiments, the method can further include collecting sift that passes through the pollen sifter screen in a sift catcher. The sift catcher can be coupled to the pollen sifter.

The method can include mechanically coupling components of the herb grinder together. In many embodiments, coupling the adjustment plate to the base plate can include coupling an axial adjustment plate magnet to an axial base magnet. In some embodiments, covering the base with the cap can include coupling an axial cap magnet to the axial base magnet.

Various examples have been described with reference to certain disclosed embodiments. The embodiments are presented for purposes of illustration and not limitation. One skilled in the art will appreciate that various changes, adaptations, and modifications can be made without departing from the scope of the invention.

What is claimed is:

1. An herb grinder, comprising:
a grinding chamber including:
a base with a base plate having an interior surface, an exterior surface, and a plurality of concentric rings of base holes, and a plurality of concentric rings of base teeth, the base teeth extending away from the interior surface;
a cap configured to be coupled to the base and rotate relative to the base, the cap including a cap plate and a plurality of concentric rings of cap teeth, the cap teeth extending away from the cap plate, the cap plate opposing and being coaxial with the interior surface of the base plate when the cap is coupled to the base, each of the concentric rings of cap teeth being radially aligned with a corresponding ring of the plurality of concentric rings of base holes when the cap is coupled to the base; and
an adjustment plate configured to be coupled to the exterior surface of the base plate, the adjustment plate including a plurality of concentric rings of adjustment holes, each of the concentric rings of adjustment holes being radially aligned with a corresponding ring of the plurality of concentric rings of base holes when the adjustment plate is coupled to the base plate, at least some of the adjustment holes at least partially overlapping with at least some of the base holes to form overlapping holes, wherein a combined area of the overlapping holes is smaller than a combined area of the base holes.

2. The herb grinder of claim 1, wherein the adjustment plate is configured to be coupled to the base plate in a first orientation and a second orientation, and wherein the combined area of the overlapping holes is larger when the adjustment plate is coupled to the base plate in the first orientation than when the adjustment plate is coupled to the base plate in the second orientation.

3. The herb grinder of claim 2, wherein the adjustment plate has a first notch corresponding to the first orientation and a second notch corresponding to the second orientation and each of the first and second notches are configured to individually mate with a tab in the base.

4. The herb grinder of claim 1, wherein the cap plate is between about two inches and three inches in diameter.

5. The herb grinder of claim 1, wherein the plurality of concentric rings of base holes is three concentric rings of base holes, the plurality of concentric rings of base teeth is two concentric rings of base teeth, and the plurality of concentric rings of cap teeth is three concentric rings of cap teeth.

6. The herb grinder of claim 1, further comprising:
a pollen sifter having a pollen sifter screen, the pollen sifter configured to be coupled to the grinding chamber; and
a sift catcher configured to be coupled to the pollen sifter to collect sift that passes through the pollen sifter screen.

7. The herb grinder of claim 1, wherein the base includes an axial base magnet, the cap includes an axial cap magnet, and the adjustment plate includes an axial adjustment plate magnet, and wherein the cap and the base are coupled together by the axial cap magnet and the axial base magnet, and the base and the adjustment plate are coupled together by the axial base magnet and the axial adjustment plate magnet.

8. A method of grinding herb comprising:
providing a grinding chamber with a base and a cap, the base including a base plate with an interior surface, and an exterior surface, a plurality of concentric rings of base holes, and a plurality of concentric rings of base teeth, the base teeth extending away from the interior surface;
coupling an adjustment plate to the exterior surface of the base plate, the adjustment plate including a plurality of concentric rings of adjustment holes, each of the concentric rings of adjustment holes being radially aligned with a corresponding ring of the plurality of concentric rings of base holes when the adjustment plate is coupled to the base plate, at least some of the adjustment holes at least partially overlapping with at least some of the base holes to form overlapping holes, wherein a combined area of the overlapping holes is smaller than a combined area of the base holes;
inserting an herb into the base of the grinding chamber;
coupling the base with the cap, the cap including a cap plate and a plurality of concentric rings of cap teeth, the cap teeth extending away from the cap plate, the cap plate opposing and being coaxial with the interior surface of the base plate when the cap is coupled to the base, each of the concentric rings of cap teeth being radially aligned with a corresponding ring of the plurality of concentric rings of base holes when the cap is coupled to the base; and
rotating the cap and the base relative to one another to grind the herb into ground form herb.

9. The method of claim 8, wherein the herb is cannabis.

10. The method of claim 8, further comprising:
orienting the grinding chamber such that the cap is positioned vertically above the base, wherein rotating the cap and the base relative to one another results in the herb falling through the overlapping holes in ground form.

11. The method of claim 8, further comprising:
selecting an adjustment plate orientation from multiple orientations, with each orientation corresponding to a different combined area of overlapping holes; and
wherein coupling the adjustment plate to the exterior surface of the base plate includes mating the adjustment plate in the selected adjustment plate orientation.

12. The method of claim 11, wherein the multiple orientations include a first orientation and a second orientation, the combined area of the overlapping holes being larger when the adjustment plate is coupled to the base plate in the first orientation than when the adjustment plate is coupled to the base plate in the second orientation.

13. The method of claim 12, wherein the adjustment plate has a first notch corresponding to the first orientation and a second notch corresponding to the second orientation and each of the first and second notches are configured to individually mate with a tab in the base to prevent the adjustment plate and the base plate from rotating relative to each other in either of the first or second orientations.

14. The method of claim 8, wherein rotating the cap and the base relative to one another includes manually rotating the cap and the base relative to one another.

15. The method of claim 8, wherein the plurality of concentric rings of base holes is three concentric rings of base holes, the plurality of concentric rings of base teeth is two concentric rings of base teeth, and the plurality of concentric rings of cap teeth is three concentric rings of cap teeth.

16. The method of claim 8, further comprising:
coupling a pollen sifter to the grinding chamber, the pollen sifter having a pollen sifter screen;
coupling a sift catcher to the pollen sifter;
collecting the ground form herb that has moved through the overlapping holes in the pollen sifter; and
collecting sift that has passed through the pollen sifter screen.

17. The method of claim 8, wherein coupling the adjustment plate to the base plate includes coupling an axial adjustment plate magnet to an axial base magnet, and wherein coupling the base with the cap includes coupling an axial cap magnet to the axial base magnet.
